(19) United States
(12) Patent Application Publication
(10) Pub. No.: US 2009/0142023 A1
(43) Pub. Date: Jun. 4, 2009

(54) PRODUCTION METHOD AND PRODUCTION APPARATUS FOR OPTICAL CONNECTING PARTS

(75) Inventors: Nobuhiro Hashimoto, Shizuoka-shi (JP); Tomoki Furue, Shizuoka-shi (JP); Ken Sukegawa, Shizuoka-shi (JP)

Correspondence Address: ARENT FOX LLP, 1050 CONNECTICUT AVENUE, N.W., SUITE 400, WASHINGTON, DC, 20036, US

(73) Assignee: TOMOEGAWA CO., LTD., Tokyo (JP)

(21) Appl. No.: 12/323,886

(22) Filed: Nov. 26, 2008

(30) Foreign Application Priority Data
Nov. 29, 2007 (JP) 2007-308652
Nov. 29, 2007 (JP) 2007-308654
Nov. 29, 2007 (JP) 2007-308658

(51) Int. Cl. G02B 6/36

(52) U.S. Cl. 385/76

(57) ABSTRACT

A production method for an optical connecting part including an optical transmission medium having an end surface provided with a refractive index matching member, includes a step for arranging a charging device in the vicinity of the optical transmission medium and the vicinity of a dielectric member. The method also includes a step for charging the optical transmission medium by the charging device, and includes a step for supplying the refractive index matching member to the end surface of the optical transmission medium.

### BACKGROUND OF THE INVENTION

1. Technical Field

The present invention relates to a production method for an optical connecting part including an optical transmission medium with a connecting end surface provided with a refractive index matching member, and relates to a production apparatus for the optical connecting part.

2. Background Art

A method for optically connecting an optical transmission medium is disclosed in Japanese Unexamined Patent Application Publication No. 64-65512, for example. In this method, optical fibers, or an optical fiber and an optical part, are connected by applying a refractive index matching member at a connecting end surface of the optical fiber. The refractive index matching member has the same or approximately the same refractive index as that of a core of the optical fiber and is used in a liquid state or a grease state. According to this method, by applying the refractive index matching member at the end surface of the optical fiber and contacting the optical fiber or the optical part with the refractive index matching member, inclusion of air at the connecting end surface can be avoided. Therefore, Fresnel reflection due to the air is avoided, and connecting loss is decreased.

In this method, a predetermined amount of the refractive index matching member, in a liquid state or a grease state, is applied at the end surface of the optical fiber, which is a very small area. Therefore, when the application amount of the refractive index matching member is too small, a good optical connecting structure is not formed. On the other hand, when the application amount of the refractive index matching member is too great, the refractive index matching member may extend around the side surface of the optical fiber, whereby the vicinity of the connecting portion may be contaminated, and dust may adhere thereto.

Another method for optical connection is disclosed in Japanese Unexamined Patent Application Publication No. 2005-173575, for example. In this method, a solid adhesive connecting member having a refractive index matching characteristic is closely contacted as one layer and is interposed between end surfaces of optical transmission mediums facing each other or between an end surface of an optical transmission medium and an optical part.

In this technique, the solid refractive index matching member is interposed, whereby pressure is not easily adjusted in connecting, and the optical transmission medium to be connected may be broken or damaged. Moreover, a structure for preliminarily maintaining the refractive index matching member is required before interposing.

As a technique for solving these problems, a production method for an optical connecting part is disclosed in Japanese Unexamined Patent Application Publication No. 2007-183383, for example. In this method, in a condition in which at least one of an optical transmission medium and a liquid refractive index matching member is electrically charged, an end surface of the optical transmission medium is brought close to the liquid surface of the liquid refractive index matching member so as to adsorb the liquid refractive index matching member. Then, the liquid refractive index matching member that is adsorbed is solidified in order to form a refractive index matching member.

In this production method, the amount of adsorption of the liquid refractive index matching member to the end surface of the optical transmission medium cannot be precisely controlled.

### SUMMARY OF THE INVENTION

The present invention has been completed in view of the above circumstances, and an object of the present invention is to provide a production method and a production apparatus for an optical connecting part. In the production method, an appropriate amount of a refractive index matching member is reproducibly provided only at an end surface of an optical transmission medium, whereby a good optical connecting structure is formed.

According to a first aspect of the present invention, the present invention provides a production method for an optical connecting part including an optical transmission medium with an end surface provided with a refractive index matching member. The production method of the first aspect of the present invention including a step for arranging a charging device in the vicinity of the optical transmission medium and a dielectric member, a step for electrically charging the optical transmission medium by the charging device, and a step for supplying the refractive index matching member at the end surface of the optical transmission medium. In the present invention, a refractive index matching member dissolved or dispersed in a solvent is used as a liquid refractive index matching member.

According to a first aspect of the present invention, the present invention provides a production apparatus for an optical connecting part including a maintaining device on which an optical transmission medium is placed, and including a charging device arranged in the vicinity of the optical transmission medium. In addition, a dielectric member is arranged in the vicinity of the maintaining device and the charging device.

According to a second aspect of the present invention, the present invention provides a production method for an optical connecting part including an optical transmission medium with an end surface provided with a refractive index matching member. The production method of the second aspect of the present invention uses a storing device for the refractive index matching member, and the storing device is provided with a concave portion for maintaining a liquid refractive index matching member and a slit for supplying an appropriate amount of the liquid refractive index matching member. This production method includes a step for supplying the liquid refractive index matching member to the concave portion, a step for charging the optical transmission medium by a charging device, and a step for supplying the liquid refractive index matching member to the end surface of the optical transmission medium. In the present invention, a refractive index matching member dissolved or dispersed in a solvent is used as a liquid refractive index matching member.

According to a second aspect of the present invention, the present invention provides a production apparatus for an optical connecting part. The production apparatus includes a maintaining device on which an optical transmission medium is placed, and a charging device arranged in the vicinity of the optical transmission medium. The production apparatus also includes a storing device for a refractive index matching member, and the storing device is provided with a concave portion for maintaining a liquid refractive index matching member and a slit for supplying an appropriate amount of the liquid refractive index matching member.

According to a third aspect of the present invention, the present invention provides a production method for an optical connecting part including an optical transmission medium with an end surface provided with a refractive index matching member. The production method of the third aspect of the present invention includes a step for charging the optical transmission medium by a charging device and a step for supplying a liquid refractive index matching member to the end surface of the optical transmission medium. The liquid refractive index matching member has a viscosity of not less than 0.005 Pa·s and not more than 1000 Pa·s, and the step for charging is performed at not more than 40% relative humidity. In the present invention, a refractive index matching member dissolved or dispersed in a solvent is used as a liquid refractive index matching member.

According to a third aspect of the present invention, the present invention provides a production apparatus for an optical connecting part. The production apparatus includes a maintaining device on which an optical transmission medium is placed, a charging device arranged in the vicinity of the optical transmission medium, and a humidity regulating device for regulating relative humidity to be not more than 40%.

According to the production method for the optical connecting part of the first aspect of the present invention, a dielectric member is arranged in the vicinity of the optical transmission medium to be supplied with a liquid refractive index matching member and is arranged in the vicinity of the charging device. Therefore, electrostatic charge applied to the optical transmission medium is stabilized in the vicinity of an end surface thereof, and the liquid refractive index matching member is reproducibly supplied only at the end surface of the optical transmission medium. Accordingly, the refractive index matching member is inhibited from extending around the side surface of the optical transmission medium, and a core of the optical transmission medium is accurately positioned in incorporating the optical transmission medium into an optical connector, whereby a good optical connecting structure is formed. According to the production apparatus for the optical connecting part of the first aspect of the present invention, a dielectric member is arranged in the vicinity of the optical transmission medium to be supplied with a liquid refractive index matching member and is arranged in the vicinity of the charging device. Therefore, electrostatic charge applied to the optical transmission medium is stabilized, and the liquid refractive index matching member is reproducibly supplied only at an end surface of the optical transmission medium.

According to the production method for the optical connecting part of the second aspect of the present invention, a storing device for a refractive index matching member is used. The storing device is provided with a concave portion for maintaining a liquid refractive index matching member and is provided with a slit for supplying an appropriate amount of the liquid refractive index matching member to an end surface of the optical transmission medium. Therefore, an appropriate amount of the refractive index matching member is reproducibly supplied only at the end surface of the optical transmission medium. Accordingly, the refractive index matching member is inhibited from extending around the side surface of the optical transmission medium, and a core of the optical transmission medium is accurately positioned in incorporating the optical transmission medium into an optical connector, whereby a good optical connecting structure is formed. According to the production apparatus for the optical connecting part of the second aspect of the present invention, the storing device for a refractive index matching member is provided with a concave portion for maintaining a liquid refractive index matching member and a slit for supplying an appropriate amount of the liquid refractive index matching member to an end surface of the optical transmission medium. Therefore, the amount of the refractive index matching member to be supplied to the end surface of the optical transmission medium is appropriately controlled.

According to the production method for the optical connecting part of the third aspect of the present invention, the liquid refractive index matching member has a viscosity of not less than 0.005 Pa·s and not more than 1000 Pa·s, and the step for charging is performed at not more than 40% relative humidity. Therefore, reproducibility of supplying an appropriate amount of the liquid refractive index matching member to an end surface of the optical transmission medium is further improved. As a result, the refractive index matching member is inhibited from extending around the side surface of the optical transmission medium, and a core of the optical transmission medium is accurately positioned in incorporating the optical transmission medium into an optical connector, whereby a good optical connecting structure is formed.

### BRIEF DESCRIPTION OF THE DRAWINGS

FIG. 1 is a top view showing an embodiment of a production apparatus for an optical connecting part of the first aspect of the present invention.

FIG. 2 is a side view showing an embodiment of a production apparatus for an optical connecting part of the first aspect of the present invention.

FIG. 3 is a perspective view showing an embodiment of a storing device for a refractive index matching member in a production apparatus for an optical connecting part of the first aspect of the present invention.

FIG. 4 is a top view showing an embodiment of a production apparatus for an optical connecting part of the second aspect of the present invention.

FIG. 5 is a side view showing an embodiment of a production apparatus for an optical connecting part of the second aspect of the present invention.

FIG. 6 is a side view showing a structure in which a refractive index matching member was supplied only at an end surface of an optical transmission medium by the production method for the optical connecting part of the second aspect of the present invention.

FIG. 7 is a side view showing a structure in which a refractive index matching member was supplied to an end surface of an optical transmission medium and extended around the side surface thereof, performed by a production method for an optical connecting part disclosed in Japanese Unexamined Patent Application Publication No. 2007-183383.

### PREFERRED EMBODIMENT OF THE INVENTION

### (1) First Embodiment

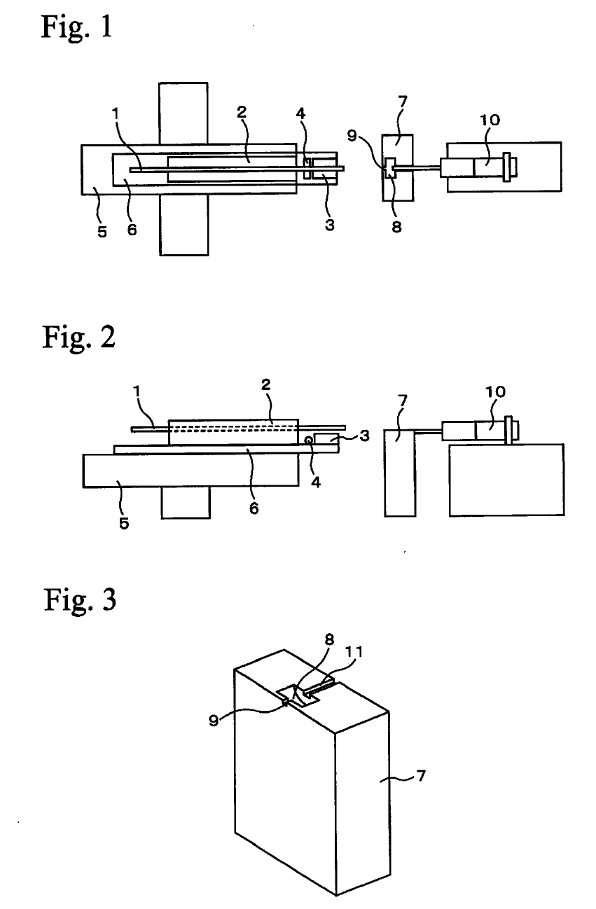

A first embodiment of the production method and the production apparatus for an optical connecting part in the present invention will be specifically described with reference to the figures. FIGS. 1 and 2 are a top view and a side view showing an embodiment of a production apparatus for an optical connecting part of the first aspect of the present invention, respectively, and an optical fiber is used as an optical transmission medium. In the production apparatus for an optical connecting part of the first aspect of the present invention, as shown in FIGS. 1 and 2, an optical fiber 1 is placed on a maintaining device 2 for an optical transmission medium. Moreover, a charging device 3 is provided in the vicinity of an end surface of the optical fiber 1, at which a refractive index matching member will be supplied, and is arranged so as not to contact the optical fiber 1, and a dielectric member 4 is also arranged. The maintaining device 2 and the charging device 3 are apposed on a shifting device 6 that is movable with respect to a frame 5, and the end surface of the optical fiber 1 can be shifted toward and counter to a storing device 7 for a refractive index matching member by the shifting device 6. Hereinafter, these components will be described in detail.

As an optical transmission medium used in the present invention, any material that transmits light, such as an optical fiber and an optical waveguide, may be used. The optical fiber may be made of any material such as quartzes and plastics, and the material is appropriately selected depending on the intended use. The optical fiber of the present invention is formed by covering an optical fiber strand consisting of a core and a cladding with resin. In an end portion of the optical fiber, which will be contacted with an optical member, the cover from the end to a portion apart from the end is removed by several tens of millimeters, and the end is cut. In the present invention, the end of the optical fiber may be obliquely cut or may be cut in a curved shape, because the coating of the refractive index matching member is finely formed at the end surface of the optical fiber even when the end of the optical fiber has such a shape. As an optical waveguide, a polyimide optical waveguide, a PMMA optical waveguide, or an epoxy waveguide may be used. In the present invention, an electrical charge in the optical transmission medium is preferably removed by an anti-static brush before production of an optical connecting part. By removing the electrical charge, the liquid refractive index matching member may be precisely supplied at the end portion of the optical transmission medium.

The refractive index matching member of the present invention has the same or approximately the same refractive index as the refractive index of an optical transmission medium for optical connection and the refractive index of one of another optical transmission medium and an optical part. The optical transmission medium and another optical transmission medium or the optical part are optically connected via the refractive index matching member, whereby connecting loss is decreased. The refractive index of the refractive index matching member of the present invention is not specifically limited as long as the refractive index is similar to that of the optical transmission medium. In addition, the difference in the refractive indexes of the refractive index matching member and the optical transmission medium is preferably within ±0.1 and is more preferably within ±0.05 in view of decreasing transmission loss by avoiding Fresnel reflection. When the difference in the refractive indexes of the optical transmission medium and another optical transmission medium or the optical part is large, an average value of the refractive indexes of the optical transmission medium and another optical transmission medium or the optical part is used, and the difference between the average value and the refractive index of the refractive index matching member is preferably within the above range.

Any member may be used as a refractive index matching member, as long as the member adheres to another optical transmission medium or the optical part with an appropriate tackiness when the member is contacted therewith. A material, which is removable from the optical transmission medium, which does not exhibit cohesion failure, and which has an adhesive substance that does not adhere to the optical transmission medium that is removed, is preferably used. According to the refractive index matching member made of such a material, the refractive index matching member is not easily damaged even when the surface of the optical transmission medium is uneven and has a burr. Moreover, since the refractive index matching member adheres to the surface of the optical transmission medium with tackiness, the optical transmission medium is easily adhered to the surface of another optical transmission medium, and this condition is maintained. In addition, a high degree of pressure is not required in adhering the optical transmission medium to another optical transmission medium, whereby the optical transmission medium is not broken or damaged. Since the refractive index matching member is removable, the refractive index matching member can be repeatedly used by adhering and removing plural times.

As a material for the refractive index matching member, specifically, a polymer material such as various kinds of adhesive material of the acryl type, epoxy type, vinyl type, silicone type, rubber type, urethane type, methacryl type, nylon type, bisphenol type, diol type, polyimide type, fluorinated epoxy type, and fluorinated acryl type, is preferably used. In particular among these, from the viewpoint of environment resistance and adhesive characteristics, the acryl type adhesive material and the silicone type adhesive material are more preferably used. Cross-linking agents, additives, flexibility imparting agents, and adhesive strength adjusting agents may be added in the material in order to appropriately adjust the adhesive strength and wettability, and water resistance, humidity resistance, and thermal resistance may be imparted to the material. The viscosity of the liquid refractive index matching member is not specifically limited, and a viscosity of approximately 0.005 to 200 Pa·s is preferable.

The refractive index matching member of the present invention is made of a single layer. Unlike a member made of plural layers, the refractive index matching member does not include an interface at which different materials contact each other, and may include a structure in which materials are uniformly mixed on the order of a wavelength of light. That is, the refractive index matching member has a very simple structure made of an adhesive single layer, and the member having such a single layer structure allows the optical transmission medium to be connected without causing light reflection to occur and to be connected at low loss.

The maintaining device for the optical transmission medium of the present invention maintains the optical transmission medium and maintains the optical transmission medium in an insulated condition when electrostatic charge is applied thereto by a charging device. Therefore, the maintaining device is preferably made of an insulating material. The maintaining device is preferably provided with a V-shaped groove in order to precisely adjust the position of the optical transmission medium.

As a charging device of the present invention, any device that can apply electrostatic charge to the optical transmission medium may be used, and an electrostatic inducing device, such as an electrostatic chuck, and a frictional charging device, such as a rotational friction device, may be used, for example. In the present invention, electrostatic charge is applied in a condition in which the optical transmission medium and the charging device are contacted or separated from each other, and this separation distance is preferably not more than 10 mm. When the separation distance is more than 10 mm, electrostatic charge is not sufficiently applied to the optical transmission medium.

The dielectric member of the present invention is arranged in the vicinity of the optical transmission medium to be supplied with a liquid refractive index matching member and is arranged in the vicinity of the charging device. The dielectric member stabilizes electrostatic charge, which is applied to the optical transmission medium, in the vicinity of the end surface thereof. Therefore, the liquid refractive index matching member is reproducibly supplied only at the end surface of the optical transmission medium. The dielectric member 4 is arranged in the vicinity of the optical fiber 1 in FIGS. 1 and 2, and the dielectric member 4 may be mounted on the optical fiber 1 as a ferrule. As the dielectric member of the present invention, a dielectric member with a dielectric constant of not less than 2 and not more than 2000 at 1 MHz is preferable, a dielectric member with a dielectric constant of 5 to 2000 at 1 MHz is more preferable, and a dielectric member with a dielectric constant of 10 to 2000 at 1 MHz is further preferable. The dielectric member of the present invention is preferably made of zirconia or alumina, and specifically, a zirconia ferrule is preferably used as the dielectric member. In the present invention, the area in the vicinity includes the adjacent area.

The shifting device of the present invention is mounted with the maintaining device for the optical transmission medium and the charging device that are apposed. The shifting device is shifted along an approximately horizontal direction with respect to the frame by a driving device formed by assembling a motor and a ball screw structure, for example. Thus, the end surface, which will be supplied with a refractive index matching member, of the optical transmission medium is shifted toward and counter to the storing device for the refractive index matching member. The operation of the shifting device may be electronically controlled by a control circuit.

The storing device 7 for the refractive index matching member of the present invention is preferably provided with a concave portion 8 for maintaining a liquid refractive index matching member and a slit 9 for supplying an appropriate amount of the liquid refractive index matching member to the end surface of the optical transmission medium, as shown in FIG. 3. The liquid refractive index matching member may be supplied to the concave portion 8 by using a dispenser 10 as shown in FIGS. 1 and 2, for example. The dispenser 10 appropriately supplies the liquid refractive index matching member maintained in a cylinder to the concave portion 8 through a nozzle. In this case, a guide groove 11 for leading the nozzle of the dispenser 10 to the concave portion 8 may be provided so that the guide groove 11 contacts the concave portion 8.

The width of the slit 9 is formed so that the liquid refractive index matching member supplied to the concave portion 8 does not leak until electrostatic charge is applied to the end surface of the optical transmission medium by the charging device 3. The width of the slit 9 is also formed so that an appropriate amount of the liquid refractive index matching member is supplied to the end surface of the optical transmission medium when electrostatic charge is applied to the end surface of the optical transmission medium by the charging device 3. In the present invention, the width of the slit 9 depends on the viscosity of the liquid refractive index matching member and the like. The width of the slit 9 is preferably not less than 10 μm and not more than 10 times as much as the width of the end surface of the optical transmission medium, and more preferably 0.5 to 5 times as much as the width of the end surface of the optical transmission medium. For example, when an optical fiber has an end surface with a width of 0.25 mm, the width of the slit may be approximately 0.5 mm.

The concave portion 8 has a rectangular parallelepiped shape in FIG. 1, but the concave portion 8 preferably has a semicylindrical shape or a hemispherical shape as shown in FIG. 3 in consideration of the removal of the liquid refractive index matching member. The storing device 7 is preferably made of a material that does not have affinity for the liquid refractive index matching member, such as Teflon (registered trade name), in view of supplying the liquid refractive index matching member to the concave portion 8 and to the end surface of the optical transmission medium through the slit, and removing it from the concave portion 8. The operation of the dispenser 10 may be electronically controlled by a control circuit, which is the same as the case of the driving device.

Next, the production method for the optical part using the above production apparatus is described. First, the optical fiber 1 is placed on a V-shaped groove provided on the maintaining device 2. Thus, the optical fiber 1 is arranged near the charging device 3. The dielectric member 4 is arranged in the vicinity of the optical fiber 1 and the vicinity of the charging device 3. The maintaining device 2 is shifted toward the storing device 7 by the shifting device 6, and the end surface of the optical fiber 1 is brought close to the slit 9 of the storing device 7 so as to have a separation distance of 10 to 1000 μm therebetween. If the separation distance is not within this range, an appropriate amount of the refractive index matching member is not easily supplied to the end surface of the optical transmission medium, which is undesirable.

In this arrangement condition, the liquid refractive index matching member in the dispenser 10 is preliminarily supplied to the concave portion 8 of the storing device 7. The liquid refractive index matching member is preferably preliminarily supplied to the concave portion immediately before a step for applying electrostatic charge to the optical transmission medium, which is described hereinafter, in order to avoid a change in the quality of the material of the liquid refractive index matching member and inclusion of dust in the liquid refractive index matching member.

Then, high voltage is applied to the optical fiber 1 by the charging device 3, and electrostatic charge is applied to the optical fiber 1. In this case, the electrostatic charge applied to the optical fiber 1 is stabilized in the vicinity of the optical fiber 1 by the dielectric member 4. By the Coulomb force of the electrostatic charge applied to the optical fiber 1, the liquid refractive index matching member, which has been preliminarily supplied to the concave portion 8, is attracted to the optical fiber 1, and a part of the liquid refractive index matching member is supplied to the end surface of the optical fiber 1 through the slit 9 of the storing device 7. Thus, the supply amount of the liquid refractive index matching member to the optical fiber 1 is stably controlled by the dielectric member 4, whereby the liquid refractive index matching member is supplied only at the end surface of the optical fiber 1. At this time, the refractive index matching member bridges the end surface of the optical fiber and the slit by surface tension.

After the application of high voltage is stopped, the maintaining device 2 is shifted by the shifting device 6 so that the end surface of the optical fiber 1 is separated from the storing device 7, and the liquid refractive index matching member is cut. Then, the optical fiber 1 is pulled out from the V-shaped groove provided on the maintaining device 2. This optical fiber 1 is heated at 100° C. for 1.5 hours, for example, whereby the solvent in the liquid refractive index matching member is volatilized, and a coating of the refractive index matching member is formed only at the end surface of the optical fiber 1.

### (2) Second Embodiment

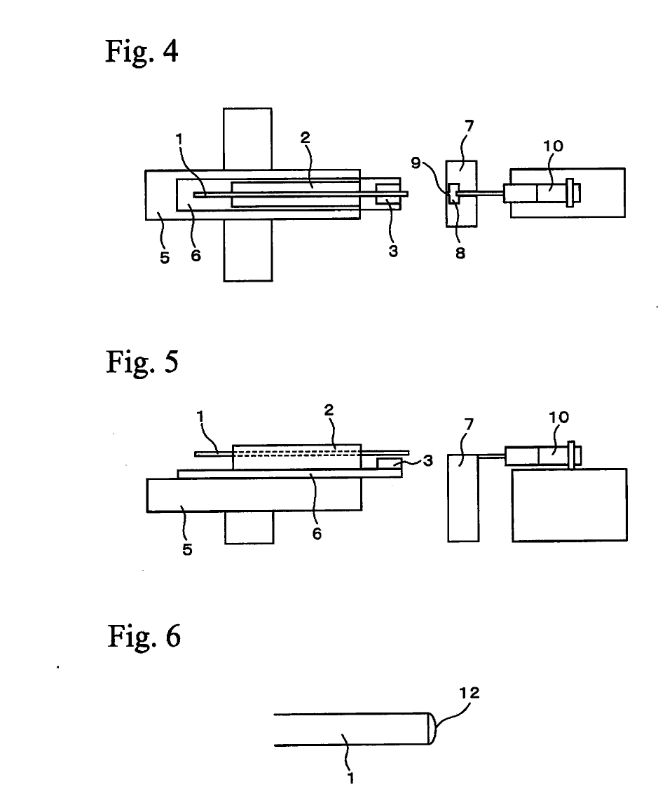

A second embodiment of the production method and the production apparatus for an optical connecting part in the present invention will be specifically described with reference to the figures. FIGS. 4 and 5 are a top view and a side view showing an embodiment of a production apparatus for an optical connecting part of the second aspect of the present invention, respectively, and an optical fiber is used as an optical transmission medium. In the production apparatus for an optical connecting part of the second aspect of the present invention, as shown in FIGS. 4 and 5, an optical fiber 1 is placed on a maintaining device 2 for an optical transmission medium. Moreover, a charging device 3 is provided in the vicinity of an end surface of the optical fiber 1, at which a refractive index matching member will be supplied, and is arranged so as not to contact the optical fiber 1. The maintaining device 2 and the charging device 3 are apposed on a shifting device 6 that is movable with respect to a frame 5, and the end surface of the optical fiber 1 can be shifted toward and counter to a storing device 7 for a refractive index matching member by the shifting device 6. The storing device 7 has a concave portion 8, and the concave portion 8 has a rectangular parallelepiped shape in FIG. 4, but the concave portion 8 preferably has a semicylindrical shape or a hemispherical shape as shown in FIG. 3 in view of removing a liquid refractive index matching member. In the second embodiment, the components similar to those in the first embodiment have the same reference numerals, and descriptions for the components having similar effects as those of the components in the first embodiment are omitted.

The production method for the optical part using the above production apparatus is described. First, the optical fiber 1 is placed on a V-shaped groove provided to the maintaining device 2 in the same manner as in the first embodiment. The optical fiber 1 is arranged near the charging device 3. The maintaining device 2 is shifted toward the storing device 7 by the shifting device 6, and an end surface of the optical fiber 1 is brought close to a slit 9 of the storing device 7 so as to have a separation distance of 10 to 1000 μm therebetween. If the separation distance is not within this range, an appropriate amount of the refractive index matching member is not easily supplied to the end surface of the optical transmission medium, which is undesirable.

In this arrangement condition, a liquid refractive index matching member in a dispenser 10 is preliminarily supplied to the concave portion 8 of the storing device 7. The liquid refractive index matching member is preferably preliminarily supplied to the concave portion 8 immediately before a step for applying electrostatic charge to the optical transmission medium in order to avoid a change in the quality of the material of the liquid refractive index matching member and inclusion of dust in the liquid refractive index matching member.

Then, high voltage is applied to the optical fiber 1 by the charging device 3, and electrostatic charge is applied to the optical fiber 1. By the Coulomb force of the electrostatic charge applied to the optical fiber 1, the liquid refractive index matching member, which has been preliminarily supplied to the concave portion 8, is attracted to the optical fiber 1, and a part of the liquid refractive index matching member is supplied to an end surface of the optical fiber 1 through the slit 9 of the storing device 7. Thus, the supply amount of the liquid refractive index matching member to the optical fiber 1 is stably controlled by the slit 9, whereby the liquid refractive index matching member is supplied only at the end surface of the optical fiber 1. At this time, the refractive index matching member bridges the end surface of the optical fiber and the slit by surface tension.

After the application of high voltage is stopped, the maintaining device 2 is shifted by the shifting device 6 so that the end surface of the optical fiber 1 is separated from the storing device 7, and the liquid refractive index matching member is cut. Then, the optical fiber 1 is pulled out from the V-shaped groove provided on the maintaining device 2. The optical fiber 1 may be heated at 100° C. for 1.5 hours, for example, whereby the solvent in the liquid refractive index matching member is volatilized, and a coating of the refractive index matching member is formed only at the end surface of the optical fiber 1.

### (3) Third Embodiment

A third embodiment of the production method and the production apparatus for an optical connecting part in the present invention will be specifically described with reference to the figures. A production apparatus for an optical connecting part of the third aspect of the present invention is the same as that shown in FIGS. 1 and 2 in the first embodiment, and an optical fiber is used as an optical transmission medium. In the production apparatus for an optical connecting part of the third aspect of the present invention, as shown in FIGS. 1 and 2, an optical fiber 1 is placed on a maintaining device 2 for an optical transmission medium. Moreover, a charging device 3 is provided in the vicinity of the optical fiber 1, and a dielectric member 4 is preferably arranged in the vicinity of the optical fiber 1. The maintaining device 2 and the charging device 3 are apposed on a shifting device 6 that is movable with respect to a frame 5, and an end surface of the optical fiber 1 can be shifted toward and counter to a storing device 7 for a refractive index matching member by the shifting device 6. The storing device 7 has a concave portion 8, and the concave portion 8 has a rectangular parallelepiped shape in FIG. 1, but the concave portion 8 preferably has a semicylindrical shape or a hemispherical shape as shown in FIG. 3 in consideration of the removal of a liquid refractive index matching member. In the third embodiment, the components similar to those in the first embodiment have the same reference numerals, and descriptions for the components having similar effects as those of the components in the first embodiment are omitted.

The liquid refractive index matching member of the present invention must have a viscosity of not less than 0.005 Pa·s and not more than 1000 Pa·s. The liquid refractive index matching member preferably has a viscosity of not less than 0.01 Pa·s and not more than 200 Pa·s. By setting the liquid refractive index matching member to have a viscosity in such range, and by setting the humidity to be not more than 40% RH in a step for charging, which is described hereinafter, reproducibility of supplying an appropriate amount of the liquid refractive index matching member to the end surface of the optical transmission medium is further improved. When the viscosity of the liquid refractive index matching member is more than 1000 Pa·s, the reproducibility of supplying an appropriate amount of the liquid refractive index matching member to the end surface of the optical transmission medium is decreased. When the humidity is more than 40% RH in a step for charging, electrostatic charge applied to the optical transmission medium is not stabilized in the vicinity of the end surface thereof, and the reproducibility of supplying an appropriate amount of the liquid refractive index matching member to the end surface of the optical transmission medium is decreased.

In the third embodiment of the present invention, the step for charging must be performed at not more than 40% relative humidity by an existing humidity regulating device. By forming such environment, electrostatic charge applied to the optical transmission medium is stabilized in the vicinity of the end surface thereof, and the reproducibility of supplying an appropriate amount of the liquid refractive index matching member to the end surface of the optical transmission medium is further improved. In a low-humidity environment, the reproducibility is high even when a liquid refractive index matching member with a viscosity of 0.01 Pa·s or more is used, whereby the amount of solvent in the liquid refractive index matching member can be reduced, and a material having a high viscosity may be freely selected and used.

In the third embodiment of the present invention, a dielectric member is preferably arranged in the vicinity of the optical transmission medium and the vicinity of the charging device as necessary. The dielectric member of the present invention stabilizes electrostatic charge, which is applied to the optical transmission medium, in the vicinity of the end surface thereof. Therefore, the liquid refractive matching member can be reproducibly supplied only at the end surface of the optical transmission medium. The dielectric member 4 is arranged in the vicinity of the end surface of the optical fiber 1 so as not to contact the optical fiber 1 in FIGS. 1 and 2, and the dielectric member 4 may be mounted on the optical fiber 1 as a ferrule. As the dielectric member of the present invention, a dielectric member that is publicly known may be used, a dielectric member made of zirconia is preferably used, and a zirconia ferrule is more preferably used.

A production method for an optical part using the above production apparatus is described hereinafter. In the third embodiment, an optical part is produced in the same manner as in the first embodiment. In this case, electrostatic charge is applied to the optical fiber 1 by applying high voltage by the charging device 3, which is performed at not more than 40% relative humidity.

### PRACTICAL EXAMPLE

Hereinafter, a production method for the optical connecting part of the present invention is further described in detail by using practical examples. It should be noted that the present invention is not limited to these practical examples.

### (1) Practical Example 1

An optical fiber (produced by the Furukawa Electric Co., Ltd., outer diameter 250 μm, outer diameter of cladding 125 μm) was prepared as an optical transmission medium. The cover of the optical fiber from an end to a portion apart from the end by 20 mm was removed so as to expose an optical fiber strand, and the optical fiber strand was cut at a portion that was 10 mm from the end. Then, 100 parts of a solution of 30% ethyl acetate of an acrylic type resin consisting of n-butyl acrylate/methyl acrylate/acrylic acid/2-hydroxy ethyl methacrylate copolymer (mixing ratio; 82/15/2.7/0.3) was mixed with 1.0 parts of CORONATE L (produced by Nippon Polyurethane Industrial Co., Ltd., tolylenediisocyanate adduct of trimethylolpropane). Thus, a liquid refractive index matching member having a refractive index of 1.46 and a viscosity of 0.1 Pa·s was prepared.

As shown in FIGS. 1 and 2, the optical fiber is arranged on the V-shaped groove of a holder (maintaining device for an optical transmission medium) produced by the Furukawa Electric Co., Ltd., so that the optical fiber was separated from an electrostatic chuck (charging device) by 200 μm. In addition, a tubular dielectric member made of zirconia and having a diameter of 1.5 to 3.0 mm and a length of 10 mm was arranged in the vicinity of the optical fiber and the vicinity of the charging device. The dielectric constant of the zirconia was 33 at 1 MHz. The end surface of the optical fiber was separated from a slit of a storing device for a refractive index matching member by 100 μm, and a concave portion of the storing device was preliminarily supplied with the liquid refractive index matching member. In this case, the width of the slit was 0.5 mm.

Next, 3 kV voltage was applied to the electrostatic chuck so as to apply electrostatic charge to the optical fiber, and a portion of the liquid refractive index matching member in the concave portion was supplied to the end surface of the optical fiber through the slit of the storing device. Then, when 1.5 seconds elapsed after the application of the voltage was stopped, the holder was shifted by a shifting device so that the end surface of the optical fiber was separated from the storing device, whereby the liquid refractive index matching device was cut. The optical fiber was heated at 100° C. for 1.5 hours so as to volatilize the solvent in the liquid refractive index matching member, and a coating with a film thickness of 25 μm of the refractive index matching member was formed only at the end surface of the optical fiber, whereby an optical connecting part of the present invention was produced.

The optical connecting part produced in the above manner was contacted to an end surface of an optical fiber, which was not polished, via the refractive index matching member, and the optical connecting part and the optical fiber were connected. In this case, the return loss was 55 dB, and the connecting loss was 0.1 dB. A total of 100 pieces of the optical connecting part were produced at 25° C. and 30% relative humidity, and a rate of success in forming the refractive index matching member only at the end surface of the optical fiber was 96%. In comparison, 100 pieces of the optical connecting part were produced in the same manner as the above manner without using the dielectric member, and the rate of success was 82%. Therefore, according to the production method for the optical connecting part of the first aspect of the present invention, a good optical connecting structure can be formed.

### (2) Practical Example 2

An optical transmission medium and a liquid refractive index matching member were prepared in the same manner as in the Practical Example 1. As shown in FIGS. 4 and 5, the optical fiber was arranged in the same manner as in the Practical Example 1. Then, after an end surface of the optical fiber was brought close to the slit of the storing device so as to have a separation distance of 100 μm therebetween, the liquid refractive index matching member was preliminarily supplied to the concave portion of the storing device.

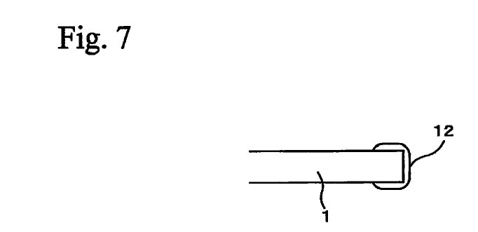

An optical connecting part of the present invention was produced in the same manner as in the Practical Example 1. The optical connecting part was contacted with an end surface of an optical fiber, which was not polished, via the refractive index matching member, and the optical connecting part and the optical fiber were connected. In this case, the return loss was 55 dB, and the connecting loss was 0.1 dB. A total of 100 pieces of the optical connecting part were produced at 25° C. and 30% relative humidity, and a rate of success in forming the refractive index matching member 12 only at the end surface of the optical fiber 1 as shown in FIG. 6 was 82%. In comparison, 100 pieces of the optical connecting part were produced in the same manner as the above manner except that a protective wall as shown in FIG. 4 disclosed in Japanese Unexamined Patent Application Publication No. 2007-183383 was used instead of the slit. In this case, the rate of success was 20%. In 80% of these pieces of the optical connecting part, the refractive index matching member 12 was formed at not only the end surface of the optical fiber 1 but also the side surface thereof as shown in FIG. 7. Therefore, according to the production method for the optical connecting part of the second aspect of the present invention, a good optical connecting structure can be formed.

### (3) Practical Example 3

An optical connecting part was produced in the same manner as in the Practical Example 1 except that the step for charging was performed at 40% relative humidity.

### Comparative Example 1

An optical connecting part was produced in the same manner as in the Practical Example 1 except that the step for charging was performed at 50% relative humidity.

### Comparative Example 2

The liquid refractive index matching member was half hardened by exposing it for three days so as to have a viscosity of 1200 Pa·s or more, and it was then used. A production method was performed in the same manner as in the Practical Example 1, except for the preparation of the liquid refractive index matching member, but the refractive index matching member did not adhere to the end surface of the optical transmission medium, and an optical connecting part could not be produced.

Each of the production method of the Practical Example 3 and the Comparative Examples 1 and 2 was repeated 100 times, and the rate of success was investigated. A success was counted when an optical connecting part, in which a refractive index matching member was not formed at the side surface of an optical fiber and adhered at the end surface of the optical fiber at an appropriate amount, was produced. As a result, in the Practical Example 3, the rate of success was 88%, and the reproducibility was extremely improved. In contrast, in the Comparative Example 1, the refractive index matching member frequently extended around the side surface of the optical fiber, and the rate of success was only 16%. In the Comparative Example 2, optical connecting parts could not be produced.

The optical connecting part produced by the production method of the Practical Example 3 was contacted with an end surface of an optical fiber, which was not polished, via the refractive index matching member, and the optical connecting part and the optical fiber were connected. In this case, the return loss was 55 dB, and the connecting loss was 0.1 dB. Therefore, according to the production method for the optical connecting part of the third aspect of the present invention, a good optical connecting structure can be formed.

The primary conditions of the practical examples and the comparative examples are shown in the following Table 1, and the results thereof are shown in Table 2.

TABLE 1

| | | Dielectric member | Slit | Temperature · humidity | Viscosity |
|---|---|---|---|---|---|
| Practical | Invention example | with dielectric member | with slit | 25° C. · 30% | 0.1 Pa · s |
| example 1 | Comparative example | without dielectric member | with slit | 25° C. · 30% | 0.1 Pa · s |
| Practical | Invention example | without dielectric member | with slit | 25° C. · 30% | 0.1 Pa · s |
| example 2 | Comparative example | without dielectric member | without slit | 25° C. · 30% | 0.1 Pa · s |
| Practical | Invention example | with dielectric member | with slit | 25° C. · 40% | 0.1 Pa · s |
| example 3 | Comparative example 1 | with dielectric member | with slit | 25° C. · 50% | 0.1 Pa · s |
| | Comparative example 2 | with dielectric member | with slit | 25° C. · 30% | 1200 Pa · s |

TABLE 2

| | | Rate of success |
|---|---|---|
| Practical | Invention example | 96% |
| example 1 | Comparative example | 82% |
| Practical | Invention example | 82% |
| example 2 | Comparative example | 20% |
| Practical | Invention example | 88% |
| example 3 | Comparative example 1 | 16% |
| | Comparative example 2 | — |

What is claimed is:

1. A production method for an optical connecting part including an optical transmission medium having an end surface provided with a refractive index matching member, the method comprising:
a step for arranging a charging device in the vicinity of the optical transmission medium and the vicinity of a dielectric member;
a step for charging the optical transmission medium by the charging device; and
a step for supplying the refractive index matching member to the end surface of the optical transmission medium.

2. The production method for the optical connecting part according to claim 1, wherein the dielectric member has a dielectric constant of not less than 2 and not more than 2000 at 1 MHz.

3. The production method for the optical connecting part according to claim 1, wherein the dielectric member is made of zirconia.

4. The production method for the optical connecting part according to claim 1, wherein the dielectric member is a zirconia ferrule mounted on the optical transmission medium.

5. A production apparatus for an optical connecting part, comprising:
a maintaining device on which an optical transmission medium is placed; and
a charging device arranged in the vicinity of the optical transmission medium,
wherein a dielectric member is arranged in the vicinity of the maintaining device and the vicinity of the charging device.

6. The production apparatus for the optical connecting part according to claim 5, wherein the dielectric member has a dielectric constant of not less than 2 and not more than 2000 at 1 MHz.

7. The production apparatus for the optical connecting part according to claim 5, wherein the dielectric member is made of zirconia.

8. The production apparatus for the optical connecting part according to claim 5, wherein the dielectric member is a zirconia ferrule mounted on the optical transmission medium.

9. A production method for an optical connecting part including an optical transmission medium having an end surface provided with a refractive index matching member,
the method using a storing device for the refractive index matching member, the storing device provided with a concave portion for maintaining a liquid refractive index matching member and a slit for supplying an appropriate amount of the liquid refractive index matching member, the method comprising:
a step for supplying the liquid refractive index matching member to the concave portion;
a step for charging the optical transmission medium by a charging device; and,
a step for supplying the liquid refractive index matching member to the end surface of the optical transmission medium.

10. The production method for the optical connecting part according to claim 9, wherein the charging device is an electrostatic chuck.

11. The production method for the optical connecting part according to claim 9, wherein the slit has a width that is not less than 10 μm and not more than 10 times as much as the width of the end surface of the optical transmission medium.

12. The production method for the optical connecting part according to claim 9, wherein the concave portion has one of a semicylindrical shape and a hemispherical shape.

13. A production apparatus for an optical connecting part, comprising:
a maintaining device on which an optical transmission medium is placed;
a charging device arranged in the vicinity of the optical transmission medium; and
a storing device for a refractive index matching member, the storing device provided with a concave portion for maintaining the liquid refractive index matching member and provided with a slit for supplying an appropriate amount of the liquid refractive index matching member.

14. The production apparatus for the optical connecting part according to claim 13, wherein the charging device is an electrostatic chuck.

15. The production apparatus for the optical connecting part according to claim 13, wherein the optical transmission medium has an end surface, and the slit has a width that is not less than 10 μm and not more than 10 times as much as the width of the end surface of the optical transmission medium.

16. The production apparatus for the optical connecting part according to claim 13, wherein the concave portion has one of a semicylindrical shape and a hemispherical shape.

17. A production method for an optical connecting part including an optical transmission medium having an end surface provided with a refractive index matching member, the method comprising:
a step for charging the optical transmission medium by a charging device; and
a step for supplying a liquid refractive index matching member to the end surface of the optical transmission medium,
wherein the liquid refractive index matching member has a viscosity of not less than 0.005 Pa·s and not more than 1000 Pa·s, and
wherein the step for charging is performed under an environment of not more than 40% relative humidity.

18. The production method for the optical connecting part according to claim 17, wherein the liquid refractive index matching member has a viscosity of not less than 0.01 Pa·s and not more than 200 Pa·s.

19. The production method for the optical connecting part according to claim 17, wherein the environment of not more than 40% relative humidity is formed by a humidity regulating device.

20. A production apparatus for an optical connecting part, comprising:
a maintaining device on which an optical transmission medium is placed;
a charging device arranged in the vicinity of the optical transmission medium; and
a humidity regulating device for adjusting an environment so as not to have more than 40% relative humidity.
